(19) United States
(12) Patent Application Publication
(10) Pub. No.: US 2024/0157810 A1
(43) Pub. Date: May 16, 2024

(54) CONTROL APPARATUS AND PROGRAM

(71) Applicant: DENSO CORPORATION, Kariya-city (JP)

(72) Inventors: Harumi HORIHATA, Kariya-city (JP); Shinichi OKADA, Kariya-city (JP)

(73) Assignee: DENSO CORPORATION, Kariya-city (JP)

(21) Appl. No.: 18/418,896

(22) Filed: Jan. 22, 2024

Related U.S. Application Data
(63) Continuation of application No. PCT/JP2022/025571, filed on Jun. 27, 2022.

(30) Foreign Application Priority Data
Jul. 20, 2021 (JP) 2021-119992

(51) Int. Cl. B60L 15/20; H02P 27/06; H02P 29/032

(52) U.S. Cl. CPC B60L 15/20; H02P 27/06; H02P 29/032; B60L 2240/12; B60L 2240/425; B60L 2240/427; B60L 2240/429; B60L 2240/441; B60L 2240/443; B60L 2240/642

(57) ABSTRACT

A control apparatus includes: a control unit that controls torque of a rotating electric machine by performing switching control of an inverter; a temperature sensor that detects a temperature of a temperature detection target which is at least one of the machine and the inverter; and a current sensor that detects electric current flowing through the temperature detection target and has higher responsiveness than the temperature sensor. The control unit includes an overheat protection unit that limits the torque of the machine when the temperature detection target is in an overheated state. The overheat protection unit determines whether the temperature detection target is in the overheated state based on the temperature detected by the temperature sensor when an operating point of the machine is within a continuous operation region, and based on the electric current detected by the current sensor when the operating point is within a short-time operation region.

### CROSS-REFERENCE TO RELATED APPLICATIONS

The present application is a continuation application of International Application No. PCT/JP2022/025571 filed on Jun. 27, 2022, which is based on and claims priority from Japanese Patent Application No. 2021-119992 filed on Jul. 20, 2021. The entire contents of these applications are incorporated by reference into the present application.

### BACKGROUND

### 1 Technical Field

The present disclosure relates to control apparatuses and programs.

### 2 Description of Related Art

There is known a control apparatus applied to a system that includes a rotating electric machine and an inverter (see, for example, Japanese Unexamined Patent Application Publication No. JP H07-112666 A). The control apparatus is configured to: calculate a command torque for the rotating electric machine; and perform switching control of upper-arm and lower-arm switches of the inverter so as to control the torque of the rotating electric machine to the calculated command torque.

Moreover, the control apparatus includes a temperature sensor for detecting the temperature of a temperature detection target which is at least one of the rotating electric machine and the inverter. When the temperature detected by the temperature sensor has become higher than a predetermined temperature, the control apparatus determines that the temperature detection target is in an overheated state; then the control apparatus limits the command torque, which is used for the torque control of the rotating electric machine, to be lower than the calculated command torque. Consequently, overheat protection of the temperature detection target can be ensured.

### SUMMARY

The inventors of the present application have found that the known control apparatus involves the following problem.

The operating point of the rotating electric machine is defined by the torque and rotational speed of the rotating electric machine. Moreover, operation regions of the rotating electric machine include a continuous operation region where the rotating electric machine can operate continuously, and a short-time operation region that is adjacent to the continuous operation region and on the higher-torque side and the higher-speed side of the continuous operation region. The short-time operation region is a region such that when the torque and rotational speed of the rotating electric machine are within the region, the temperature detection target may become overheated and therefore the time for which the rotating electric machine is continuously driven is limited.

The amount of heat generated by the temperature detection target is greater in the short-time operation region than in the continuous operation region; thus, the temperature increase rate of the temperature detection target tends to become higher in the short-time operation region than in the continuous operation region. Moreover, the responsiveness of the temperature sensor is generally low. Therefore, when the actual temperature of the temperature detection target increases with the operating point of the rotating electric machine being within the short-time operation region, the deviation of the temperature detected by the temperature sensor from the actual temperature of the temperature detection target may become large. Consequently, at the timing when the temperature detected by the temperature sensor reaches the predetermined temperature, the actual temperature of the temperature detection target may become considerably higher than the predetermined temperature and thus it may become impossible to ensure the overheat protection of the temperature detection target.

The present disclosure has been accomplished in view of the above problem.

According to the present disclosure, there is provided a control apparatus to be applied to a system. The system includes: a rotating electric machine including a rotor and stator windings; an electric power storage unit; and an inverter including upper-arm and lower-arm switches and electrically connecting the stator windings and the electric power storage unit. The control apparatus includes: a command calculation unit that calculates a command value which is either a command torque or a command rotational speed of the rotating electric machine; a rotating electric machine control unit that performs, based on the calculated command value, switching control of the upper-arm and lower-arm switches so as to control torque of the rotating electric machine to the command torque; a temperature sensor that detects a temperature of a temperature detection target which is at least one of the rotating electric machine and the inverter; and a current sensor that detects electric current flowing through the temperature detection target, the current sensor having higher responsiveness than the temperature sensor. Moreover, the rotating electric machine control unit includes an overheat protection unit that determines whether the temperature detection target is in an overheated state and controls the torque of the rotating electric machine to a limit torque when the temperature detection target is determined to be in the overheated state; the limit torque is lower than the command torque. Furthermore, operation regions of the rotating electric machine include a continuous operation region where the rotating electric machine can operate continuously, and a short-time operation region that is adjacent to the continuous operation region and on a higher-torque side and a higher-speed side of the continuous operation region. The overheat protection unit also determines whether an operating point of the rotating electric machine, which is defined by the torque and rotational speed of the rotating electric machine, is within the continuous operation region or the short-time operation region. When the operating point is determined to be within the continuous operation region, the overheat protection unit determines whether the temperature detection target is in the overheated state based on the temperature detected by the temperature sensor. In contrast, when the operating point is determined to be within the short-time operation region, the overheat protection unit determines whether the temperature detection target is in the overheated state based on the electric current detected by the current sensor.

As above, in the control apparatus according to the present disclosure, when the operating point of the rotating electric machine is determined to be within the short-time operation region that is on the higher-torque side and the higher-speed side of the continuous operation region, the overheat protection unit determines whether the temperature detection target is in the overheated state based on the electric current detected by the current sensor whose responsiveness is higher than that of the temperature sensor. Consequently, in a situation where the amount of heat generated by the temperature detection target tends to become large, it is possible to quickly determine whether the temperature detection target is actually in the overheated state; thus, it is possible to properly perform the overheat protection of the temperature detection target. On the other hand, when the operating point of the rotating electric machine is determined to be within the continuous operation region, the overheat protection unit determines whether the temperature detection target is in the overheated state based on the temperature detected by the temperature sensor whose responsiveness is lower than that of the current sensor. Consequently, it is possible to reduce the processing load of the rotating electric machine control unit.

### BRIEF DESCRIPTION OF THE DRAWINGS

FIG. 1 is an overall configuration diagram of a system according to a first embodiment.

FIG. 2 is a flowchart illustrating steps of an overheat protection process performed by an MGCU.

FIG. 3 is a diagram illustrating operation regions of a rotating electric machine according to the first embodiment.

FIG. 4 is a flowchart illustrating steps of a first protection control performed by the MGCU.

FIG. 5 is a diagram illustrating the relationship between a motor temperature and a limiting coefficient.

FIG. 6 is a flowchart illustrating steps of a second protection control performed by the MGCU.

FIG. 7 is a time chart illustrating the change with time of a detection error of a temperature sensor.

FIG. 8 is a time chart illustrating the difference in responsiveness between the temperature sensor and a current sensor.

FIG. 9 is a time chart illustrating the changes with time of parameters including the motor temperature detected by the temperature sensor.

FIG. 10 is a diagram illustrating the operation regions of the rotating electric machine according to a second embodiment.

FIG. 11 is a diagram illustrating the operation regions of the rotating electric machine according to a third embodiment.

FIG. 12 is a diagram illustrating the operation regions of the rotating electric machine according to a fourth embodiment.

FIG. 13 is a diagram illustrating the change in the operation regions of the rotating electric machine according to a fifth embodiment with change in a power supply voltage.

FIG. 14 is a diagram illustrating the change in the operation regions of the rotating electric machine according to the fifth embodiment with the progress of deterioration of a storage battery.

FIG. 15 is a diagram illustrating the change in the operation regions of the rotating electric machine according to the fifth embodiment with change in a carrier frequency.

FIG. 16 is a diagram illustrating the change in the operation regions of the rotating electric machine according to the fifth embodiment with change in a dead time.

FIG. 17 is a diagram illustrating the change in the operation regions of the rotating electric machine according to the fifth embodiment with change in a specific temperature.

FIG. 18 is a flowchart illustrating steps of an overheat protection process performed by the MGCU according to a sixth embodiment.

### DESCRIPTION OF EMBODIMENTS

Exemplary embodiments will be described hereinafter with reference to the drawings. It should be noted that for the sake of clarity and understanding, identical components having identical functions throughout the whole description have been marked, where possible, with the same reference signs in the drawings and that for the sake of avoiding redundancy, descriptions of identical components will not be repeated.

### First Embodiment

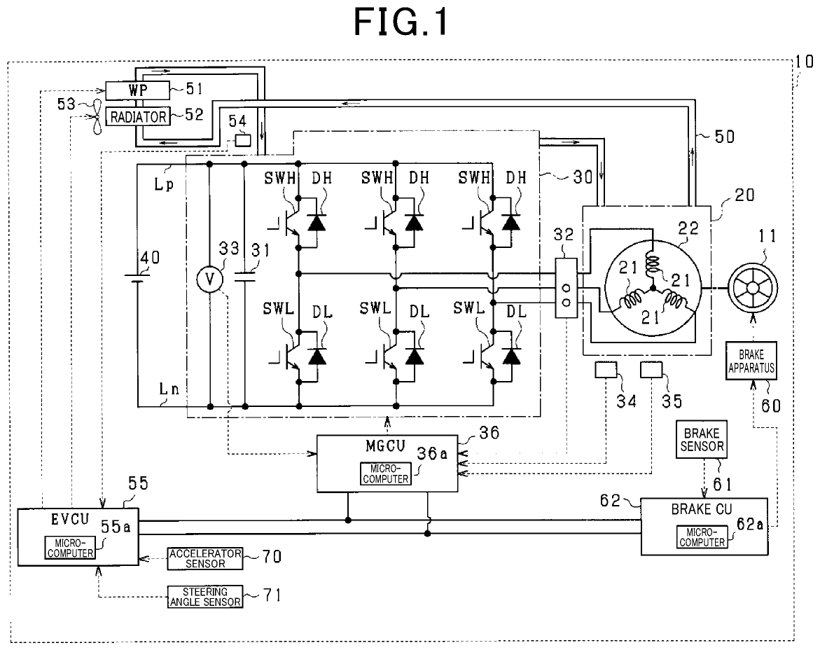

In the first embodiment, a control apparatus according to the present disclosure is applied to a system that is installed in an electric vehicle 10. Specifically, as shown in FIG. 1, the system includes a rotating electric machine 20. The rotating electric machine 20 is a three-phase synchronous machine, and has three stator windings 21 provided respectively for the three phases. The stator windings 21 are star-connected (or Y-connected) together. Moreover, the stator windings 21 are arranged so as to be offset from each other by 120° in electrical angle. More particularly, in the present embodiment, the rotating electric machine 20 is a permanent magnet synchronous machine which has permanent magnets (corresponding to “field poles”) provided in a rotor 22.

The rotating electric machine 20 is an in-vehicle main machine, and includes the rotor 22 capable of transmitting mechanical power to driving wheels 11 of the vehicle 10. Specifically, when the rotating electric machine 20 functions as an electric motor to generate torque, the generated torque is transmitted from the rotor 22 to the driving wheels 11. Consequently, the driving wheels 11 are driven by the torque to rotate. In addition, the rotating electric machine 20 may be configured, for example, as an in-wheel motor provided integrally with one of the driving wheels 11 of the vehicle 10 or as an on-board motor provided on the body (not shown) of the vehicle 11.

The system also includes an inverter 30, a capacitor 31 (corresponding to an “electric power storage unit”) and a storage battery 40. The inverter 30 has three serially-connected switch units provided respectively for the three phases; each of the serially-connected switch units consists of an upper-arm switch SWH and a lower-arm switch SWL. In the present embodiment, each of the upper-arm and lower-arm switches SWH and SWL is implemented by a voltage-controlled semiconductor switching element, more particularly by an IGBT. Therefore, each of the upper-arm and lower-arm switches SWH and SWL has a collector as a higher-potential-side terminal and an emitter a lower-potential-side terminal. Moreover, each of the upper-arm and lower-arm switches SWH and SWL has a corresponding one of upper-arm and lower-arm diodes DH and DL connected in antiparallel thereto; each of the upper-arm and lower-arm diodes DH and DL is a freewheeling diode.

In each of the three phases, a first end of the stator winding 21 is connected to both the emitter of the upper-arm switch SWH and the collector of the lower-arm switch SWL. On the other hand, all of second ends of the stator windings 21 of the three phases are connected together at a neutral point. In addition, in the present embodiment, the numbers of turns of all the stator windings 21 are set to be equal to each other.

Each of the upper-arm switches SWH of the three phases has its collector connected to a positive electrode terminal of the storage battery 40 via a positive-electrode-side bus Lp. On the other hand, each of the lower-arm switches SWL of the three phases has its emitter connected to a negative electrode terminal of the storage battery 40 via a negative-electrode-side bus Ln. Moreover, the positive-electrode-side bus Lp and the negative-electrode-side bus Ln are connected with each other via the capacitor 31. In addition, the capacitor 31 may be either built in the inverter 30 or provided outside the inverter 30.

The storage battery 40 is an assembled battery whose terminal voltage is several hundred volts. The storage battery 40 may be implemented by, for example, a secondary battery such as a lithium-ion battery or a nickel-metal hydride battery.

The system further includes a current sensor 32, a voltage sensor 33, a rotation angle sensor 34, a motor temperature sensor 35 and an MGCU 36 (Motor Generator Control Unit, corresponding to a “rotating electric machine control unit”). The current sensor 32 detects at least two of three phase currents respectively flowing through the three stator windings 21. The voltage sensor 33 detects the terminal voltage of the capacitor 31. The rotation angle sensor 34 detects the rotation angle (or electrical angle) of the rotor 22. The rotation angle sensor 34 may be implemented by, for example, a resolver. The motor temperature sensor 35 detects the temperature of the rotating electric machine 20 as a motor temperature Tmgd. 10 More particularly, in the present embodiment, the motor temperature sensor 35 detects the temperature of at least one of the stator windings 21 as the motor temperature Tmgd. The motor temperature sensor 35 may be implemented by, for example, a thermistor. The detected values of the sensors 32 to 35 are inputted to the MGCU 36.

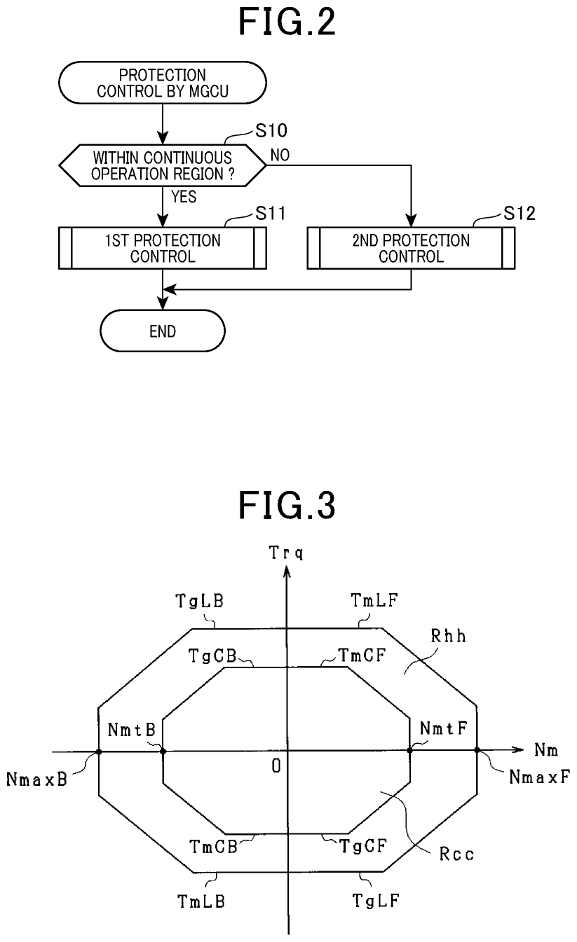

The MGCU 36 is mainly composed of a microcomputer 36a (corresponding to a “first computer”) which includes a CPU (Central Processing Unit). The functions of the microcomputer 36a may be provided by software recorded in a tangible memory device and a computer that executes it, only software, only hardware, or a combination thereof. For example, in the case of the microcomputer 36a being configured with an electronic circuit that is hardware, it may be configured with a digital circuit that includes a number of logic circuits, or with an analog circuit. The microcomputer 36a executes programs stored in a non-transitory tangible storage medium that is included in the microcomputer 36a as a storage unit. The programs include, for example, a program for performing an overheat protection process shown in FIG. 2. Moreover, methods corresponding to the programs are carried out by executing the programs. The storage unit may be, for example, a nonvolatile memory. In addition, the programs stored in the storage unit may be updated, for example by OTA (Over-The-Air), via a network such as the Internet.

The MGCU 36 receives a command torque Trq* sent from an EVCU (Electric Vehicle Control Unit) 55 which will be described later. The MGCU 36 performs switching control of the upper-arm and lower-arm switches SWH and SWL, which constitute the inverter 30, so as to control the torque of the rotating electric machine 20 to the received command torque Trq*. Specifically, in each of the three phases, the upper-arm switch SWH and the lower-arm switch SWL are turned on alternately.

The MGCU 36 performs power running drive control. The power running drive control is switching control of the inverter 30 for converting DC power outputted from the storage battery 40 into AC power and supplying the AC power to the stator windings 21. When the power running drive control is performed, the rotating electric machine 20 functions as an electric motor, generating power running torque. Moreover, the MGCU 36 also performs regenerative drive control. The regenerative drive control is switching control of the inverter 30 for converting AC power generated by the rotating electric machine 20 into DC power and supplying the DC power to the storage battery 40. When this control is performed, the rotating electric machine 20 functions as an electric generator, generating regenerative torque.

The system further includes a circulation path 50 through which cooling water circulates, and a cooling apparatus. The cooling apparatus includes an electric water pump 51, a radiator 52 and an electric fan 53. When supplied with electric power, the water pump 51 is driven to circulate cooling water. In the circulation path 50, the inverter 30 and the rotating electric machine 20 are arranged in this order downstream of the water pump 51. However, the arrangement order of the rotating electric machine 20 and the inverter 30 in the circulation path 50 is not limited to the above-described order.

The radiator 52 is provided between the inverter 30 and the water pump 51 in the circulation path 50. The radiator 52 cools the cooling water flowing thereinto through the circulation path 50 and supplies it to the water pump 51. The cooling water flowing into the radiator 52 is cooled by air blown onto the radiator 52 during traveling of the vehicle 10, or by air blown onto the radiator 52 by driving the fan 53 to rotate.

The system further includes a cooling water temperature sensor 54 and the EVCU 55 (corresponding to a “command calculation unit”). The cooling water temperature sensor 54 detects the temperature of the cooling water flowing to the inverter 30 in the circulation path 50. The detected value of the cooling water temperature sensor 54 is inputted to the EVCU 55.

The EVCU 55 is mainly composed of a microcomputer 55a (corresponding to a “second computer”) which includes a CPU. In the present embodiment, the EVCU 55 corresponds to a superordinate control unit of the MGCU 36 and a brake CU (Control Unit) 62 that will be described later. The functions of the microcomputer 55a may be provided by software recorded in a tangible memory device and a computer that executes it, only software, only hardware, or a combination thereof. For example, in the case of the microcomputer 55a being configured with an electronic circuit that is hardware, it may be configured with a digital circuit that includes a number of logic circuits, or with an analog circuit. The microcomputer 55a executes programs stored in a non-transitory tangible storage medium that is included in the microcomputer 55a as a storage unit. The programs include, for example, a program for performing a process of driving the above-described cooling apparatus. Moreover, methods corresponding to the programs are carried out by executing the programs. The storage unit may be, for example, a nonvolatile memory. In addition, the programs stored in the storage unit may be updated, for example by OTA (Over-The-Air), via a network such as the Internet.

The system further includes a mechanical brake apparatus 60, a brake sensor 61 and the aforementioned brake CU 62. The brake apparatus 60 applies frictional braking torque to the wheels of the vehicle 10 including the driving wheels 11. The brake apparatus 60 includes a master cylinder, brake pads and the like; the master cylinder operates according to the amount of depression of a brake petal. The brake sensor 61 detects a brake stroke that is the amount of depression of the brake pedal; the brake pedal is a brake operation member manipulated by the vehicle driver. The detected value of the brake sensor 61 is inputted to the brake CU 62.

The brake CU 62 is mainly composed of a microcomputer 62a (corresponding to a “third computer”) which includes a CPU. The functions of the microcomputer 62a may be provided by software recorded in a tangible memory device and a computer that executes it, only software, only hardware, or a combination thereof. For example, in the case of the microcomputer 62a being configured with an electronic circuit that is hardware, it may be configured with a digital circuit that includes a number of logic circuits, or with an analog circuit. The microcomputer 62a executes programs stored in a non-transitory tangible storage medium that is included in the microcomputer 62a as a storage unit. The programs include, for example, a program for performing a process of controlling the braking force of the brake apparatus 60. Moreover, methods corresponding to the programs are carried out by executing the programs. The storage unit may be, for example, a nonvolatile memory. In addition, the programs stored in the storage unit may be updated, for example by OTA (Over-The-Air), via a network such as the Internet.

The MGCU 36, the EVCU 55 and the brake CU 62 can exchange information with each other using a predetermined communication format (e.g., CAN).

The system further includes an accelerator sensor 70 and a steering angle sensor 71. The accelerator sensor 70 detects an accelerator stroke that is the amount of depression of an accelerator pedal; the accelerator pedal is an accelerator operating member manipulated by the vehicle driver.

The steering angle sensor 71 detects the steering angle of a steering wheel of the vehicle 10; the steering wheel is manipulated by the vehicle driver. The detected values of the accelerator sensor 70 and the steering angle sensor 71 are inputted to the EVCU 55. The EVCU 55 calculates a command rotational speed Nm* of the rotor 22 on the basis of the accelerator stroke detected by the accelerator sensor 70 and the steering angle detected by the steering angle sensor 71. The EVCU 55 calculates the command torque Trq* as a manipulated variable for feedback-controlling the rotational speed of the rotor 22 to the calculated command rotational speed Nm*. The EVCU 55 sends the calculated command torque Trq* (corresponding to a “command value”) to the MGCU 36. In addition, the rotational speed of the rotor 22 may be calculated based on, for example, the detected value of the rotation angle sensor 34. Moreover, in the case of the vehicle 10 having an autonomous driving function, the EVCU 55 may calculate, when the vehicle 10 is in an autonomous driving mode, the command rotational speed Nm* on the basis of, for example, a target traveling speed of the vehicle 10 set by an autonomous driving CU of the vehicle 10.

The brake CU 62 calculates, based on the brake stroke detected by the brake sensor 61, a total braking torque Fbrk to be applied to the wheels of the vehicle 10. Moreover, the brake CU 62 receives a regenerative braking torque Fgmax sent from the EVCU 55. The regenerative braking torque Fgmax is the current maximum value of the braking torque that can be applied to the wheels of the vehicle 10 by the regenerative drive control.

The brake CU 62 calculates, based on the regenerative braking torque Fgmax and the total braking torque Fbrk, both a regenerative braking command torque Fgb and a friction braking command torque Fmb. For example, the brake CU 62 may calculate the friction braking command torque Fmb by subtracting the regenerative braking command torque Fgb from the total braking torque Fbrk.

The brake CU 62 sends the calculated regenerative braking command torque Fgb to the EVCU 55. Then, the EVCU 55 sends the received regenerative braking command torque Fgb, as the command torque Trq*, to the MGCU 36. In addition, the higher the regenerative braking command torque Fgb, the higher the electric power generated by the rotating electric machine 20 and supplied from the rotating electric machine 20 to the storage battery 40 via the inverter 30.

Moreover, the brake CU 62 sends the calculated friction braking command torque Fmb to the brake apparatus 60. Consequently, the braking torque applied to the wheels of the vehicle 10 by the brake apparatus 60 is controlled to the friction braking command torque Fmb.

Next, the overheat protection process performed by the MGCU 36 will be described with reference to FIG. 2. This process is repeatedly performed at a predetermined control cycle.

In step S10, the current torque Trq and rotational speed Nm of the rotating electric machine 20 are acquired; and it is determined whether the operating point of the rotating electric machine 20, which is defined by the current torque Trq and rotational speed Nm of the rotating electric machine 20, is within a continuous operation region. It should be noted that the current torque Trq may be represented by, for example, either the torque calculated based on the detected values of the current sensor 32 and the rotation angle sensor 34 or the command torque Trq*. Moreover, it also should be noted that the current rotational speed Nm may be calculated based on, for example, the detected value of the rotational angle sensor 34.

Referring now to FIG. 3, operation regions of the rotating electric machine 20 will be described. The operating point of the rotating electric machine 20 is defined by the torque of the rotating electric machine 20 and the rotational speed of the rotor 22. Of the operation regions of the rotating electric machine 20, the region where the torque Trq has a positive value is a region where the power running drive control is performed. On the other hand, of the operation regions, the region where the torque Trq has a negative value is a region where the regenerative drive control is performed. Moreover, of the operation regions, the region where the rotational speed Nm has a positive value is a region where the rotor 22 rotates in a first direction and the vehicle 10 travels forward. On the other hand, of the operation regions, the region where the rotational speed Nm has a negative value is a region where the rotor 22 rotates in a second direction that is opposite to the first direction and the vehicle 10 travels backward.

The operation regions of the rotating electric machine 20 include a continuous operation region Rcc where the rotating electric machine 20 can operate continuously. Specifically, the continuous operation region Rcc is a region such that when the torque of the rotating electric machine 20 and the rotational speed of the rotor 22 are within the region, the rotating electric machine 20 and the inverter 30 can be driven continuously without becoming overheated. More specifically, when the operating point of the rotating electric machine 20 is within the continuous operation region Rcc, the effective value [Arms] of the phase currents respectively flowing through the stator windings 21 is lower than or equal to an allowable upper limit current (more specifically, an all-time allowable current) of the rotating electric machine 20 (more specifically, the stator windings 21).

In that part of the continuous operation region Rcc where the rotational speed Nm has a positive value, the boundary on the higher-torque side of the region where the torque Trq has a positive value represents the upper limit of continuous torque when the power running drive control is performed (hereinafter, to be referred to as the power running forward torque upper limit TmCF); and the boundary on the higher-torque side of the region where the torque Trq has a negative value represents the upper limit of continuous torque when the regenerative drive control is performed (hereinafter, to be referred to as the regenerative forward torque upper limit TgCF). Moreover, in that part of the continuous operation region Rcc where the rotational speed Nm has a positive value, the operating point at which the torque Trq is 0 and the rotational speed Nm is highest represents a forward-side specific operating point. In addition, the rotational speed Nm which defines the forward-side specific operating point will be referred to as the forward-side specific rotational speed NmtF hereinafter.

In that part of the continuous operation region Rcc where the rotational speed Nm has a negative value, the boundary on the higher-torque side of the region where the torque Trq has a positive value represents the upper limit of continuous torque when the regenerative drive control is performed (hereinafter, to be referred to as the regenerative backward torque upper limit TgCB); and the boundary on the higher-torque side of the region where the torque Trq has a negative value represents the upper limit of continuous torque when the power running drive control is performed (hereinafter, to be referred to as the power running backward torque upper limit TmCB). Moreover, in that part of the continuous operation region Rcc where the rotational speed Nm has a negative value, the operating point at which the torque Trq is 0 and the rotational speed Nm is highest represents a backward-side specific operating point. In addition, the rotational speed Nm which defines the backward-side specific operating point will be referred to as the backward-side specific rotational speed NmtB.

Of the operation regions of the rotating electric machine 20, the other region than the continuous operation region Rcc is set to a short-time operation region Rhh. The short-time operation region Rhh is a region which is adjacent to the higher-torque-side and higher-speed-side boundaries of the continuous operation region Rcc. In other words, the short-time operation region Rhh is a region which is adjacent to the continuous operation region Rcc and on the higher-torque side and the higher-speed side of the continuous operation region Rcc. Moreover, the short-time operation region Rhh is a region such that when the torque of the rotating electric machine 20 and the rotational speed of the rotor 22 are within the region, at least one of the rotating electric machine 20 and the inverter 30 may become overheated and therefore the time for which the rotating electric machine 20 is continuously driven is limited.

In that part of the short-time operation region Rhh where the rotational speed Nm has a positive value, the boundary on the higher-torque side of the region where the torque Trq has a positive value represents the allowable upper limit TmLF of torque when the power running drive control is performed; and the boundary on the higher-torque side of the region where the torque Trq has a negative value represents the allowable upper limit TgLF of torque when the regenerative drive control is performed. Moreover, in that part of the short-time operation region Rhh where the rotational speed Nm has a positive value, the highest rotational speed NM represents the forward-side maximum rotational speed NmaxF.

In that part of the short-time operation region Rhh where the rotational speed Nm has a negative value, the boundary on the higher-torque side of the region where the torque Trq has a positive value represents the allowable upper limit TgLB of torque when the regenerative drive control is performed; and the boundary on the higher-torque side of the region where the torque Trq has a negative value represents the allowable upper limit TmLB of torque when the power running drive control is performed. Moreover, in that part of the short-time operation region Rhh where the rotational speed Nm has a negative value, the highest rotational speed Nm represents the backward-side maximum rotational speed NmaxB.

In addition, in the higher-speed-side part of the short-time operation region Rhh, the MGCU 36 performs field-weakening control of supplying field-weakening current to flow through the stator windings 21.

Referring back to FIG. 2, if it is determined in step S10 that the current operating point is within the continuous operation region Rcc, the process proceeds to step S11. In step S11, a first protection control is performed. On the other hand, if it is determined in step S10 that the current operating point is within the short-time operation region Rhh, i.e., not within the continuous operation region Rcc, the process proceeds to step S12. In step S12, a second protection control is performed.

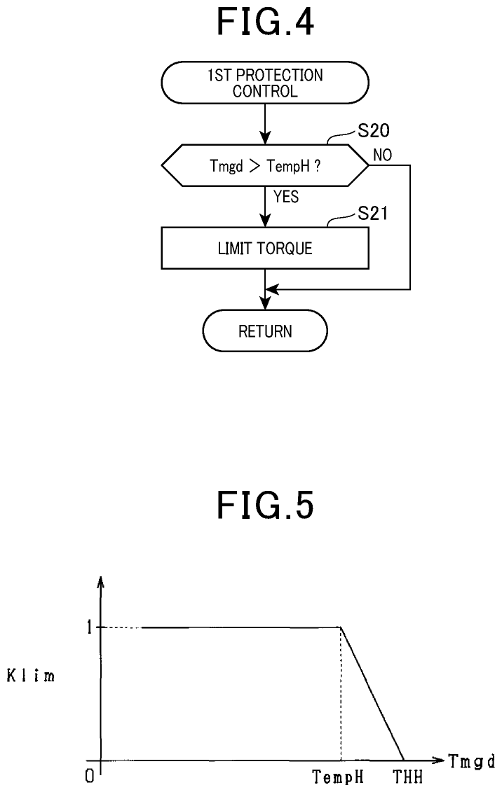

Next, the first protection control will be described with reference to FIG. 4.

In step S20, it is determined whether the motor temperature Tmgd detected by the motor temperature sensor 35 has become higher than a limit start temperature TempH. The limit start temperature TempH is set to a temperature at which it is possible to determine that at least one of the rotating electric machine 20 and the inverter 30 is in an overheated state.

If it is determined in step S20 that the motor temperature Tmgd has become higher than the limit start temperature TempH, the process proceeds to step S21.

In step S21, the switching control of the upper-arm and lower-arm switches SWH and SWL of the inverter 30 is performed so as to limit the torque of the rotating electric machine 20 to be lower than the command torque Trq* received from the EVCU 55. Specifically, the received command torque Trq* is multiplied by a limiting coefficient Klim; and the switching control of the upper-arm and lower-arm switches SWH and SWL of the inverter 30 is performed so as to control the torque of the rotating electric machine 20 to a limit torque (Klim×Trq*) that is the result of the multiplication.

As shown in FIG. 5, when the motor temperature Tmgd is lower than or equal to the limit start temperature TempH, the limiting coefficient Klim is set to 1. Moreover, when the motor temperature Tmgd is higher than the limit start temperature TempH, the limiting coefficient Klim is set such that the higher the motor temperature Tmgd, the lower the limiting coefficient Klim Furthermore, when the motor temperature Tmgd is higher than or equal to a final limit temperature THH (here, THH>TempH), the limiting coefficient Klim is set to 0.

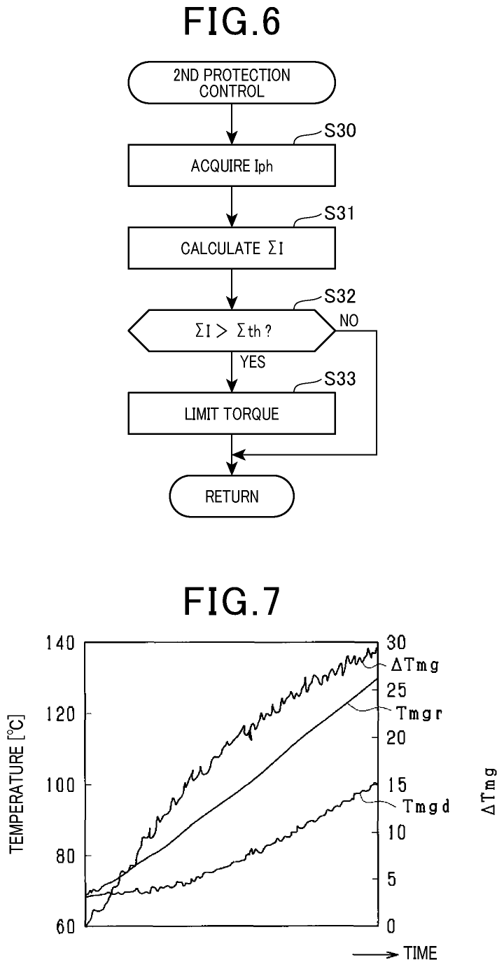

Next, the second protection control will be described with reference to FIG. 6.

In step S30, a phase current Iph detected by the current sensor 32 is acquired.

In step S31, an integration process is performed on the acquired phase current Iph. Specifically, a phase current integrated value ΣI in the current control cycle is calculated by adding the phase current Iph acquired in the current control cycle to the integrated value of the phase current Iph up to the previous control cycle. In addition, the phase current integrated value ΣI may be reset to 0 when the result of the determination in step S10 of the overheat protection process shown in FIG. 2 is affirmative (i.e., YES).

In step S32, it is determined whether the phase current integrated value ΣI is greater than an integrated value threshold Σth. The integrated value threshold Σth is set to a value with which it is possible to determine that at least one of the rotating electric machine 20 and the inverter 30 is in an overheated state.

In addition, the integrated value threshold Σth may be set to, for example, (Imax×tmax), where Imax is an allowable upper limit current and tmax is an allowable upper limit time (e.g., 30 seconds) that is the maximum value of time during which the phase currents flowing through the stator windings 21 can be continuously kept at the allowable upper limit current Imax. Moreover, the integrated value threshold Σth may be set such that the lower the temperature detected by the cooling water temperature sensor 54 or the higher the flow rate of the cooling water circulating through the circulation path 50, the greater the integrated value threshold Σth.

If the phase current integrated value ΣI is determined in step S32 to be less than or equal to the integrated value threshold Σth, it is determined that neither the rotating electric machine 20 nor the inverter 30 is in an overheated state.

On the other hand, if the phase current integrated value ΣI is determined in step S32 to be greater than the integrated value threshold Σth, it is determined that at least one of the rotating electric machine 20 and the inverter 30 is in an overheated state. Then, the process proceeds to step S33.

In step S33, the switching control of the upper-arm and lower-arm switches SWH and SWL of the inverter 30 is performed so as to control the torque of the rotating electric machine 20 to the limit torque that is lower than the command torque Trq* received from the EVCU 55, as in step S21 of the first protection control shown in FIG. 4.

In addition, the processes shown in FIGS. 2, 4 and 6 together correspond to an “overheat protection unit”.

As described above, in the present embodiment, the first protection control or the second protection control is performed depending on whether the current operating point of the rotating electric machine 20 is within the continuous operation region Rcc or the short-time operation region Rhh. The purpose of selectively performing the first protection control or the second protection control is to properly perform overheat protection of the rotating electric machine 20 and the inverter 30 when the operating point of the rotating electric machine 20 is within the short-time operation region Rhh and to reduce the processing load of the MGCU 36.

Specifically, the responsiveness of the motor temperature sensor 35 is generally low. Therefore, as shown in FIG. 7, in a transient state where the actual temperature Tmgr of the rotating electric machine 20 (i.e., the temperature detection target of the motor temperature sensor 35) increases, the error ΔTmg between the actual temperature Tmgr and the motor temperature Tmgd detected by the motor temperature sensor 35 may become large. Therefore, when the operating point of the rotating electric machine 20 is within the short-time operation region Rhh, if overheat protection of the rotating electric machine 20 and the inverter 30 is performed through the first protection control shown in FIG. 4, at the timing when the motor temperature Tmgd detected by the motor temperature sensor 35 reaches the limit start temperature TempH, the actual temperature Tmgr may become considerably higher than the limit start temperature TempH and thus it may become impossible to properly perform the overheat protection. To solve this problem, one may consider setting the limit start temperature TempH to a lower value. However, in this case, the torque liming region would be expanded, thereby lowering the driving performance of the vehicle 10.

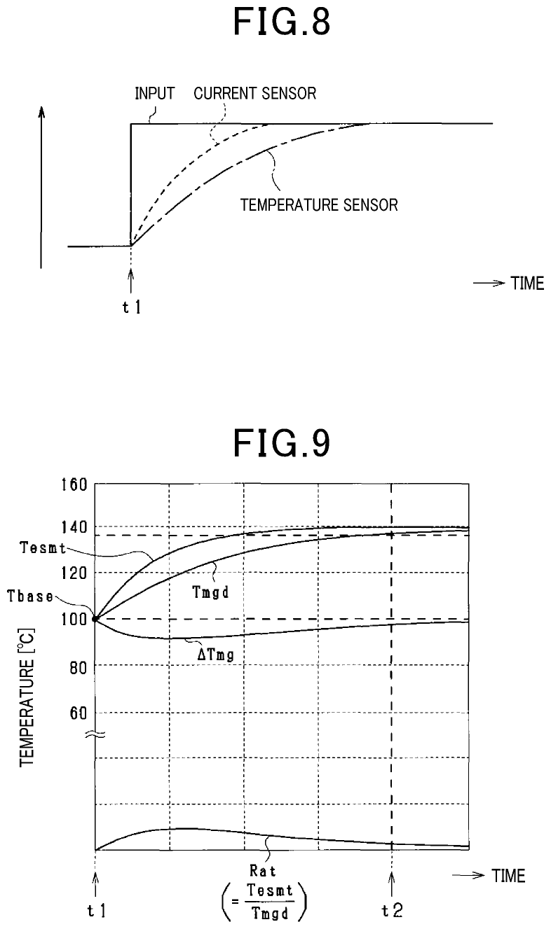

In contrast, the responsiveness of the current sensor 32 is higher than the responsiveness of the motor temperature sensor 35. FIG. 8 shows changes with time of the detected values of the sensors 32 and 35 when the physical quantities (current, temperature) as input signals to be detected are changed stepwise by a predetermined amount. As can be seen from FIG. 8, after changing the physical quantities stepwise at a time instant t1, the detected value of the current sensor 32 converges earlier than the detected value of the motor temperature sensor 35.

That is, the response time constant of the current sensor 32 is less than the response time constant of the motor temperature sensor 35. Therefore, when the operating point of the rotating electric machine 20 is within the short-time operation region Rhh, it is possible to quickly perform, through the second protection control using the detected value of the current sensor 32, overheat protection of the rotating electric machine 20 and the inverter 30 even in a transient state where the actual temperature Tmgr of the rotating electric machine 20 increases. However, due to the integration process performed on the phase current Iph, the processing load of the MGCU 36 in the second protection control is higher than that in the first protection control.

On the other hand, when the operating point of the rotating electric machine 20 is within the continuous operation region Rcc, the amount of heat generated by the rotating electric machine 20 and the inverter 30 is considerably less than that when the operating point is within the short-time operation region Rhh. Therefore, the deviation of the motor temperature Tmgd detected by the motor temperature sensor 35 from the actual temperature of the rotating electric machine 20 is relatively small.

In consideration of the above, in the present embodiment, when the operating point of the rotating electric machine 20 is within the continuous operation region Rcc, the first protection control is performed using the detected value of the motor temperature sensor 35; when the operating point is within the short-time operation region Rhh, the second protection control is performed using the detected value of the current sensor 32 that has higher responsiveness than the motor temperature sensor 35. Consequently, it becomes possible to properly perform overheat protection of the rotating electric machine 20 and the inverter 30 when the operating point of the rotating electric machine 20 is within the short-time operation region Rhh and to reduce the processing load of the MGCU 36.

### Modifications of First Embodiment

The second protection control is not limited to the one shown in FIG. 6, but may alternatively be, for example, the one described below.

In this modification, the MGCU 36 sets the motor temperature Tmgd when the current operating point of the rotating electric machine 20 transitions from the continuous operation region Rcc to the short-time operation region Rhh as a reference temperature Tbase. Then, the MGCU 36 calculates an estimated temperature Tesmt of the rotating electric machine 20 (more specifically, of the stator windings 21) based on the reference temperature Tbase and the detected value of the current sensor 32. Specifically, the MGCU 36 calculates the estimated temperature Tesmt by adding the amount of temperature increase ΔTm of the stator windings 21, which is calculated based on the detected value of the current sensor 32, to the reference temperature Tbase. Thereafter, the MGCU 36 determines whether the estimated temperature Tesmt is higher than the limit start temperature TempH. If the estimated temperature Tesmt is determined to be higher than the limit start temperature TempH, the MGCU 36 executes step S33 of FIG. 6.

In addition, after the transition of the operating point of the rotating electric machine 20 to the short-time operation region Rhh, if the detected motor temperature Tmgd and the estimated temperature Tesmt are determined to match each other, the MGCU 36 may set the motor temperature Tmgd detected near the determination timing to the reference temperature Tbase used for calculation of the estimated temperature Tesmt.

Moreover, as shown in FIG. 9, at the timing t1, the operating point of the rotating electric machine 20 transitions to the short-time operation region Rhh; and at the timing t2, a determination time has elapsed from the timing t1. After the timing t2, the MGCU 36 may perform overheat protection of the rotating electric machine 20 and the inverter 30 through the first protection control instead of the second protection control. Specifically, the timing t2 is a timing at which the detected motor temperature Tmgd and the estimated temperature Tesmt can be considered to match each other. The temperature ratio Rat shown in FIG. 9 is the ratio between the estimated temperature Tesmt and the detected motor temperature Tmgd. The MGCU 36 calculates the estimated temperature Tesmt based on the elapsed time from the timing t1, the response time constant of the current sensor 32, the reference temperature Tbase and the detected value of the current sensor 32. Further, the MGCU 36 calculates the temperature ratio Rat based on the estimated temperature Tesmt. The MGCU 36 performs the second protection control using the detected value of the current sensor 32 until the timing t2 at which the temperature ratio Rat becomes equal to a predetermined ratio (e.g., 95%). After the timing t2, the temperature ratio Rat exceeds the predetermined ratio; and the MGCU 36 performs the first protection control using the detected value of the motor temperature sensor 35 even if the operating point of the rotating electric machine 20 is within the short-time operation region Rhh.

Of the operation regions of the rotating electric machine 20, the continuous operation region Rcc may be set as a region where the field-weakening current is lower than or equal to a predetermined current. In this case, it is possible to set the continuous operation region Rcc taking into account heat generated by the copper loss due to the field-weakening current.

Alternatively, of the operation regions of the rotating electric machine 20, the continuous operation region Rcc may be set as a region where the magnitude of current vectors flowing through the stator windings 21 is lower than or equal to a predetermined value, or as a region where the total loss (e.g., the sum of the copper loss, the iron loss and the mechanical loss) occurring in the rotating electric machine 20 is less than or equal to a predetermined loss.

### Second Embodiment

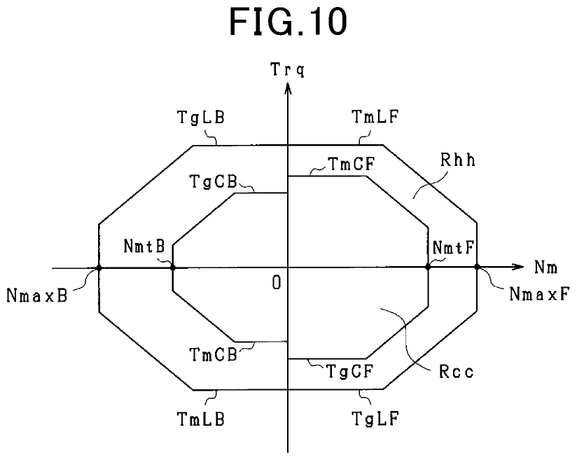

Hereinafter, the second embodiment will be described with reference to the drawings, focusing on the differences thereof from the first embodiment. In the present embodiment, as shown in FIG. 10, the method of setting the continuous operation region Rcc is changed. Specifically, the magnitudes of the power running forward torque upper limit TmCF and the regenerative forward torque upper limit TgCF are set to be higher than the magnitudes of the power running backward torque upper limit TmCB and the regenerative backward torque upper limit TgCB. This setting is based on the fact that the vehicle 10 is configured so that the amount of air blown onto the rotating electric machine 20 and the inverter 30 is greater when the vehicle 10 travels forward than when the vehicle 10 travels backward. Such a configuration of the vehicle 10 may be realized, for example, by arranging the rotating electric machine 20 and the inverter 30 near a grill in a front part of the vehicle 10.

According to the present embodiment described above, it is possible to properly set the continuous operation region Rcc of the rotating electric machine 20 in the vehicle 10 where the cooling performance of the rotating electric machine 20 and the inverter 30 is greatly influenced by the amount of air blown onto them during traveling of the vehicle 10.

### Third Embodiment

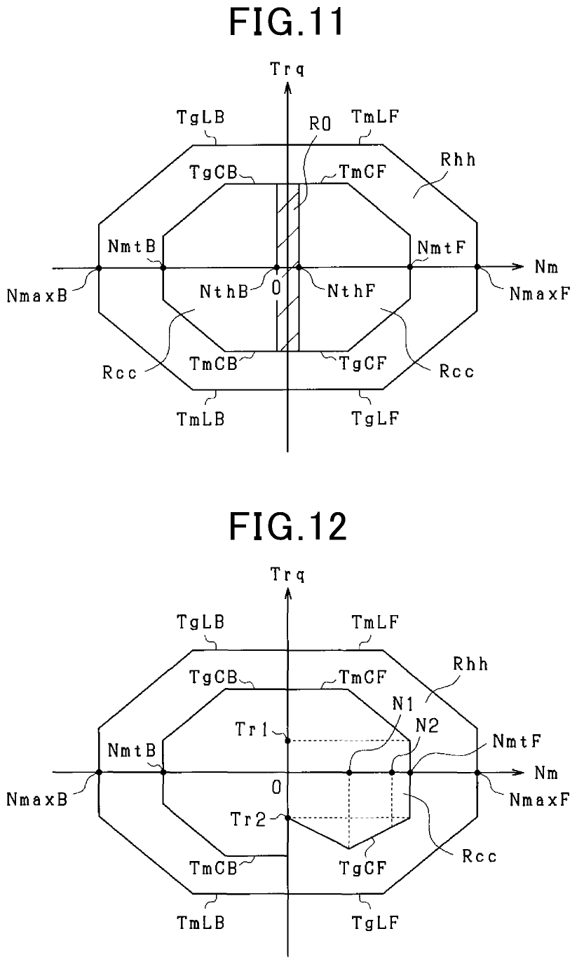

Hereinafter, the third embodiment will be described with reference to the drawings, focusing on the differences thereof from the first embodiment. In the present embodiment, as shown in FIG. 11, in the continuous operation region Rcc described in the first embodiment, a region where the rotational speed Nm is in the vicinity of 0 is set as a very-low-speed region R0. Specifically, as indicated by hatching in FIG. 11, in the continuous operation region Rcc, the very-low-speed region R0 is a region where the rotational speed Nm is in the range from a forward-side threshold NthF to a backward-side threshold NthB. The forward-side threshold NthF and the backward-side threshold NthB are set to values with which it is possible to determine that the rotor 22 is in a rotation-stopped state or in a very-low-speed rotation state where the rotor 22 rotates at a speed close to 0.

In the present embodiment, when the current operating point of the rotating electric machine 20 is determined to be within the short-time operation region Rhh or the very-low-speed region R0, the MGCU 36 performs the second protection control using the detected value of the current sensor 32. The reason for performing the second protection control when the current operating point of the rotating electric machine 20 is within the very-low-speed region R0 is that a motor lock state may occur in this case. For example, the motor lock state may occur when the vehicle 10 is on an uphill road surface and the traveling speed of the vehicle 10 becomes close to 0 due to operation of the accelerator pedal by the vehicle driver. Otherwise, the motor lock state may occur when the vehicle 10 moves over a step.

Upon occurrence of the motor lock state, electric current will concentrate on a specific phase among the three phases; thus, the amount of heat generated by the stator winding 21 of the specific phase may become excessively large. In consideration of the above, in the present embodiment, when the current operating point of the rotating electric machine 20 is within the very-low-speed region R0, the MGCU 36 performs the second protection control using the detected value of the current sensor 32.

### Fourth Embodiment

Hereinafter, the fourth embodiment will be described with reference to the drawings, focusing on the differences thereof from the first embodiment. In the present embodiment, as shown in FIG. 12, in that part of the continuous operation region Rcc where the rotational speed Nm has a positive value, the magnitudes of the power running forward torque upper limit TmCF and the regenerative forward torque upper limit TgCF corresponding to each rotational speed Nm are set to different values.

Specifically, in a lower-speed-side region of the continuous operation region Rcc where the rotational speed Nm is lower than or equal to a first speed N1, the magnitude of the regenerative forward torque upper limit TgCF is set to be lower than the magnitude of the power running forward torque upper limit TmCF. More particularly, in the present embodiment, in the lower-speed-side region, the regenerative forward torque upper limit TgCF is set such that the lower the rotational speed Nm, the lower the regenerative forward torque upper limit TgCF. This is because in that part of the lower-speed-side region where the regenerative drive control is performed, field-strengthening control is performed to supply field-strengthening current to flow through the stator windings 21. That is, in the lower-speed-side region, the induced voltage generated in the stator windings 21 is low; therefore, it is necessary to perform the field-strengthening control. In this case, the magnitude of current vectors flowing through the stator windings 21 to generate a predetermined regenerative torque becomes higher than that in the case of no field-strengthening control being performed. In consideration of the above, in the present embodiment, in the lower-speed-side region, the magnitude of the regenerative forward torque upper limit TgCF is set to be lower than the magnitude of the power running forward torque upper limit TmCF.

On the other hand, in a higher-speed-side region of the continuous operation region Rcc where the rotational speed Nm is higher than or equal to a second speed N2 (here, N2>N1) and lower than or equal to the forward-side specific rotational speed NmtF, the magnitude of the regenerative forward torque upper limit TgCF is set to be higher than the magnitude of the power running forward torque upper limit TmCF. This setting is based on the fact that: in that part of the higher-speed-side region where the torque Trq has a positive value, the field-weakening control is performed; in contrast, in that part of the higher-speed-side region where the torque Trq has a negative value, the field-weakening current for generating the predetermined regenerative torque may be set to be lower than that when the torque Trq has a positive value, or be set to 0. When the field-weakening current is low, the magnitude of current vectors flowing through the stator windings 21 to generate the predetermined regenerative torque becomes low; consequently, the magnitude of the regenerative forward torque upper limit TgCF can be increased and thus the continuous operation region Rcc can be expanded. In addition, in FIG. 12, Tr1 represents the power running forward torque upper limit TmCF when the rotational speed Nm is equal to NmtF; Tr2 represents the regenerative forward torque upper limit TgCF when the rotational speed Nm is equal to NmtF; and |Tr1|<|Tr2|.

### Fifth Embodiment

Hereinafter, the fifth embodiment will be described with reference to the drawings, focusing on the differences thereof from the first embodiment. In the present embodiment, the powering running forward torque upper limit TmCF, the regenerative forward torque upper limit TgCF, the powering running backward torque upper limit TmCB and the regenerative backward torque upper limit TgCB, which define boundaries of the continuous operation region Rcc, are set such that the lower the voltage utilization rate of the inverter 30, the lower the magnitudes of these torque upper limits Hereinafter, those of the operation regions of the rotating electric machine 20 where the rotational speed Nm has a positive value will be described as an example; the same applies to those of the operation regions of the rotating electric machine 20 where the rotational speed Nm has a negative value.

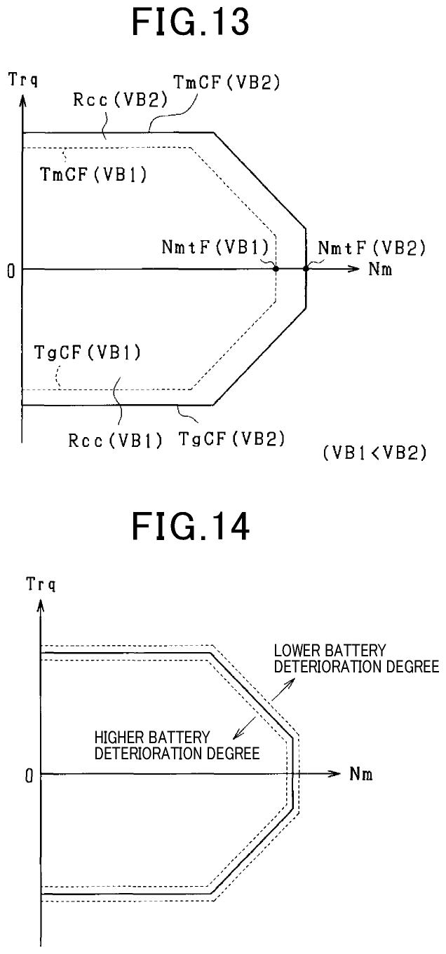

FIG. 13 illustrates both a case where the power supply voltage Vdc detected by the voltage sensor 33 is equal to a first voltage VB1 and a case where the power supply voltage Vdc is equal to a second voltage VB2 (here, VB2>VB1). In FIG. 13, Rcc (VB1) designates the continuous operation region Rcc when the power supply voltage Vdc is equal to the first voltage VB1; and Rcc (VB2) designates the continuous operation region Rcc when the power supply voltage Vdc is equal to the second voltage VB2. The same applies to the forward-side specific rotational speed NmtF, the power running forward torque upper limit TmCF and the regenerative forward torque upper limit TgCF.

As shown in FIG. 13, the lower the power supply voltage Vdc, the lower the forward-side specific rotational speed NmtF, the power running forward torque upper limit TmCF and the regenerative forward torque upper limit TgCF are set to be and thus the smaller the continuous operation region Rcc is set to be.

In addition, the SOC of the storage battery 40 may be used instead of the power supply voltage Vdc. That is, the continuous operation region Rcc may be set based on the SOC of the storage battery 40 such that the lower the SOC of the storage battery 40, the smaller the continuous operation region Rcc. Alternatively, as shown in FIG. 14, the continuous operation region Rcc may be set based on the degree of deterioration of the storage battery 40 such that the higher the degree of deterioration of the storage battery 40, the smaller the continuous operation region Rcc.

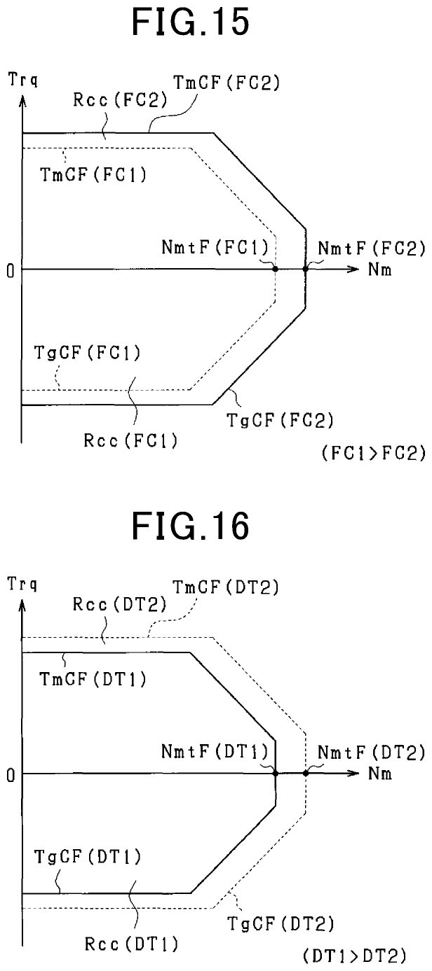

Next, referring to FIG. 15, explanation will be given of a method of setting the continuous operation region Rcc based on the frequency of a carrier signal (hereinafter, to be referred to as the carrier frequency) when the control method of the inverter 30 is PWM control. The PWM control is switching control of the upper-arm and lower-arm switches SWH and SWL for making, when the peak value of the phase voltages applied to the stator windings 21 is lower than or equal to the terminal voltage of the storage battery 40, the phase voltages have a PWM voltage waveform. Specifically, the PWM control is switching control based on a comparison between a command voltage of each phase and the carrier signal. The modulation method of the PWM control may be three-phase modulation or two-phase modulation.

FIG. 15 illustrates both a case where the carrier frequency is equal to a first frequency FC1 and a case where the carrier frequency is equal to a second frequency FC2 (here, FC2<FC1). In FIG. 15, Rcc (FC1) designates the continuous operation region Rcc when the carrier frequency is equal to the first frequency FC1; and Rcc (FC2) designates the continuous operation region Rcc when the carrier frequency is equal to the second frequency FC2. The same applies to the forward-side specific rotational speed NmtF, the power running forward torque upper limit TmCF and the regenerative forward torque upper limit TgCF.

As shown in FIG. 15, the higher the carrier frequency, the lower the voltage utilization rate becomes and therefore the lower the forward-side specific rotational speed NmtF, the power running forward torque upper limit TmCF and the regenerative forward torque upper limit TgCF are set to be and thus the smaller the continuous operation region Rcc is set to be.

In addition, the continuous operation region Rcc may be set based on whether the control method of the inverter 30 is the PWM control, overmodulation control or rectangular wave control. The overmodulation control is switching control of the upper-arm and lower-arm switches SWH and SWL for making, when the peak value of the phase voltages applied to the stator windings 21 is higher the terminal voltage of the storage battery 40, the phase voltages have a PWM voltage waveform whose modulation factor is higher than that of the PWM voltage waveform obtained by the PWM control. The rectangular wave control is switching control of turning on each of the upper-arm and lower-arm switches SWH and SWL of each phase once in one electrical angle period with a dead time provided between the on-periods of the upper-arm and lower-arm switches SWH and SWL.

Moreover, the continuous operation region Rcc may be set based on whether the modulation method is two-phase modulation or three-phase modulation.

Next, referring to FIG. 16, explanation will be given of a method of setting the continuous operation region Rcc based on the dead time. FIG. 16 illustrates both a case where the dead time is equal to a first time DT1 and a case where the dead time is equal to a second time DT2 (here, DT2<DT1). In FIG. 16, Rcc (DT1) designates the continuous operation region Rcc when the dead time is equal to the first time DT1; and Rcc (DT2) designates the continuous operation region Rcc when the dead time is equal to the second time DT2. The same applies to the forward-side specific rotational speed NmtF, the power running forward torque upper limit TmCF and the regenerative forward torque upper limit TgCF.

As shown in FIG. 16, the longer the dead time, the lower the voltage utilization rate becomes and therefore the lower the forward-side specific rotational speed NmtF, the power running forward torque upper limit TmCF and the regenerative forward torque upper limit TgCF are set to be and thus the smaller the continuous operation region Rcc is set to be.

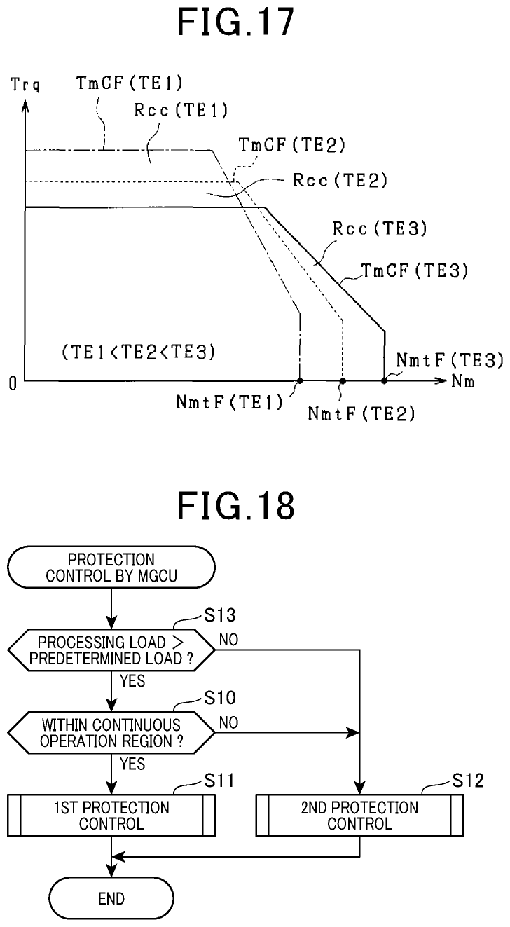

Alternatively, as shown in FIG. 17, the continuous operation region Rcc may be set based on a specific temperature which is any one of the temperatures of the switches SWH and SWL of the inverter 30, the temperatures of the stator windings 21 and the temperatures of the permanent magnets of the rotor 22. FIG. 17 illustrates a case where the specific temperature is equal to a first temperature TE1, a case where the specific temperature is equal to a second temperature TE2 and a case where the specific temperature is equal to a third temperature TE3 (here, TE1<TE2<TE3). It should be noted that the regeneration-side operation region is not shown in FIG. 17. Moreover, in FIG. 17, Rcc (TE1) designates the continuous operation region Rcc when the specific temperature is equal to the first temperature TE1; Rcc (TE2) designates the continuous operation region Rcc when the specific temperature is equal to the second temperature TE2; and Rcc (TE3) designates the continuous operation region Rcc when the specific temperature is equal to the third temperature TE3. The same applies to the forward-side specific rotational speed NmtF and the power running forward torque upper limit TmCF.

As shown in FIG. 17, the lower the specific temperature, the greater the amount of magnetic flux of the permanent magnets of the rotor 22 becomes and therefore the lower the forward-side specific rotational speed NmtF, the power running forward torque upper limit TmCF and the regenerative forward torque upper limit TgCF are set to be and thus the smaller the continuous operation region Rcc is set to be.

According to the present embodiment described above, it is possible to properly perform overheat protection of the rotating electric machine 20 and the inverter 30 according to the state of the system.

### Sixth Embodiment

Hereinafter, the sixth embodiment will be described with reference to the drawings, focusing on the differences thereof from the first embodiment. In the present embodiment, when the processing load of the MGCU 36 is lower than or equal to a predetermined load, the second protection control is performed using the detected value of the current sensor 32 regardless of whether the current operating point of the rotating electric machine 20 is within the continuous operation region or the short-time operation region.

FIG. 18 is a flowchart illustrating an overheat protection process performed by the MGCU 36 according to the present embodiment. It should be noted that for the sake of convenience, in FIG. 18, the same reference signs are assigned to the same steps as those shown in FIG. 2.

In step S13, it is determined whether the processing load of the MGCU 36 is higher than the predetermined load.

If the processing load is determined in step S13 to be lower than or equal to the predetermined load, the process proceeds to step S10.

On the other hand, if the processing load is determined in step S13 to be higher than the predetermined load, the process proceeds to step S12, in which the second protection control is performed using the detected value of the current sensor 32. In addition, the processing load may become higher than the predetermined load when, for example, the MGCU 36 performs a process of sending traveling information of the vehicle 10 to another vehicle or a server apparatus via a network such as the Internet.

As above, in the present embodiment, when there is leeway in the processing load of the MGCU 36, the second protection control is performed regardless of whether the current operating point of the rotating electric machine 20 is within the short-time operation region. Consequently, overheat protection of the rotating electric machine 20 and the inverter 30 can be more properly performed. On the other hand, when there is no leeway in the processing load of the MGCU 36, the second protection control is performed on condition that the current operating point of the rotating electric machine 20 is within the short-time operation region. Consequently, it becomes possible to perform overheat protection of the rotating electric machine 20 and the inverter 30 without employing a microcomputer with high processing capacity as the microcomputer 36a of the MGCU 36, while preventing occurrence of an overflow in the processing of the MGCU 36.

### Seventh Embodiment

Hereinafter, the seventh embodiment will be described with reference to the drawings, focusing on the differences thereof from the first embodiment. In the present embodiment, the method of setting the continuous operation region Rcc is changed. For example, any one of the following three methods may be used for setting the continuous operation region Rcc.

### First Method

According to the first method, the forward-side specific rotational speed NmtF is set to the rotational speed Nm of the rotor 22 (i.e., the rotational speed Nm of the rotating electric machine 20) which is assumed when the vehicle 10 travels on a road at a legal maximum speed. For example, the forward-side specific rotational speed NmtF may be set to the rotational speed Nm of the rotor 22 which is assumed when the vehicle 10 travels steadily on a highway at a legal maximum speed (e.g., 120 km/h). Alternatively, the forward-side specific rotational speed NmtF may be set to the rotational speed Nm of the rotor 22 which is assumed when the vehicle 10 travels steadily on a local road (or ordinary road) at a legal maximum speed (e.g., 60 km/h).

### Second Method

According to the second method, the forward-side specific rotational speed NmtF is set to the rotational speed Nm of the rotor 22 at which traveling speed of the vehicle 10 reaches a terminal speed when the vehicle 10 travels on a road with a predetermined downhill slope without frictional braking torque applied by the brake apparatus 60 to the wheels of the vehicle 10 and without mechanical power applied by mechanical power generation apparatuses including the rotating electric machine 10 to the driving wheels 11. For example, when the vehicle 10 includes, in addition to the rotating electric machine 20, an internal combustion engine as a driving power source, the mechanical power generation apparatuses are the rotating electric machine 20 and the internal combustion engine.

### Third Method

According to the third method, the forward-side specific rotational speed NmtF is set to the rotational speed Nm of the rotor 22 at which a peak value of line-to-line voltages becomes equal to the terminal voltage of the capacitor 31; the line-to-line voltages are induced in the stator windings 21 with rotation of the rotor 22 without field-weakening current flowing through the stator windings 21. In addition, both the forward-side specific rotational speed NmtF set according to the first method and the forward-side specific rotational speed NmtF set according to the second method may be lower than or equal to the rotational speed Nm of the rotor 22 at which the peak value of the line-to-line voltages becomes equal to the terminal voltage of the capacitor 31.

### Other Embodiments

The above-described embodiments may be modified and implemented as follows.

In the processes according to the above-described embodiments including the process shown in FIG. 4, the temperature of the inverter 30 or the higher one of the motor temperature Tmgd and the temperature of the inverter 30 may be used instead of the motor temperature Tmgd. In addition, the temperature of the inverter 30 may be detected by, for example, a sensor (e.g., a temperature-sensitive diode or a thermistor) that detects the temperature of at least one of the upper-arm and lower-arm switches SWH and SWL that constitute the inverter 30.

The EVCU 55 may send the command rotational speed Nm* to the MGCU 36. In this case, the MGCU 36 may calculate the command torque Trq* as a manipulated variable for feedback-controlling the rotational speed Nm of the rotor 22 to the command rotational speed Nm* received from the EVCU 55.

The current sensor 32 is not limited to the one that detects electric currents flowing between the inverter 30 and the stator windings 21 of the rotating electric machine 20. Instead, the current sensor 32 may be, for example, a current sensor that detects electric currents flowing between the lower-arm switches SWL of the respective phases and the negative-electrode-side bus Ln or a current sensor that detects electric currents flowing between the upper-arm switches SWH of the respective phases and the positive-electrode-side bus Lp.

Each of the semiconductor switching elements constituting the inverter 30 is not limited to an IGBT. Instead, each of the semiconductor switching elements constituting the inverter 30 may be, for example, an N-channel MOSFET having a body diode built therein. In this case, each of the upper-arm and lower-arm switches SWH and SWL has a drain as the higher-potential-side terminal and a source as the lower-potential-side terminal.

The functions of the EVCU 55, the MGCU 36 and the brake CU 62 may be integrated into a single CU (Control Unit).

The mobile object in which the system including the rotating electric machine 20 and the inverter 30 is installed is not limited to a vehicle, but may alternatively be, for example, an aircraft or a ship. Furthermore, the installation destination of the system is not limited to mobile objects.

The control apparatus and the control method described in the present disclosure may be realized by a dedicated computer that includes a processor, which is programmed to perform one or more functions embodied by a computer program, and a memory. As an alternative, the control apparatus and the control method described in the present disclosure may be realized by a dedicated computer that includes a processor configured with one or more dedicated hardware logic circuits. As another alternative, the control apparatus and the control method described in the present disclosure may be realized by one or more dedicated computers configured with a combination of a processor programmed to perform one or more functions, a memory and a processor configured with one or more dedicated hardware logic circuits. In addition, the computer program may be stored as computer-executable instructions in a computer-readable non-transitory tangible recording medium.

While the present disclosure has been described pursuant to the above-described embodiments, it should be appreciated that the present disclosure is not limited to these embodiments and the structures. Instead, the present disclosure encompasses various modifications and changes within equivalent ranges. In addition, various combinations and modes are also included in the category and the scope of technical idea of the present disclosure.

What is claimed is:

1. A control apparatus to be applied to a system,
the system comprising:
a rotating electric machine including a rotor and stator windings;
an electric power storage unit; and
an inverter including upper-arm and lower-arm switches and electrically connecting the stator windings and the electric power storage unit,
the control apparatus comprising:
a command calculation unit that calculates a command value which is either a command torque or a command rotational speed of the rotating electric machine;
a rotating electric machine control unit that performs, based on the calculated command value, switching control of the upper-arm and lower-arm switches so as to control torque of the rotating electric machine to the command torque;
a temperature sensor that detects a temperature of a temperature detection target which is at least one of the rotating electric machine and the inverter; and
a current sensor that detects electric current flowing through the temperature detection target, the current sensor having higher responsiveness than the temperature sensor,
wherein
the rotating electric machine control unit includes an overheat protection unit that determines whether the temperature detection target is in an overheated state and controls the torque of the rotating electric machine to a limit torque when the temperature detection target is determined to be in the overheated state, the limit torque being lower than the command torque,
wherein
operation regions of the rotating electric machine include a continuous operation region where the rotating electric machine can operate continuously, and a short-time operation region that is adjacent to the continuous operation region and on a higher-torque side and a higher-speed side of the continuous operation region,
the overheat protection unit also determines whether an operating point of the rotating electric machine, which is defined by the torque and rotational speed of the rotating electric machine, is within the continuous operation region or the short-time operation region,
when the operating point is determined to be within the continuous operation region, the overheat protection unit determines whether the temperature detection target is in the overheated state based on the temperature detected by the temperature sensor, and
when the operating point is determined to be within the short-time operation region, the overheat protection unit determines whether the temperature detection target is in the overheated state based on the electric current detected by the current sensor.

2. The control apparatus as set forth in claim 1, wherein
the system is installed in a vehicle that has a driving wheel to which mechanical power is transmitted from the rotor of the rotating electric machine,
the vehicle travels forward when the rotor rotates in a first direction, and travels backward when the rotor rotates in a second direction that is opposite to the first direction,
the vehicle is configured so that the amount of air blown onto the temperature detection target is greater when the vehicle travels forward than when the vehicle travels backward, and
in the continuous operation region, a torque upper limit defining a boundary of a region where the rotor rotates in the first direction is set to be higher than a torque upper limit defining a boundary of a region where the rotor rotates in the second direction.

3. The control apparatus as set forth in claim 1, wherein
the operation regions of the rotating electric machine further include a very-low-speed region where the rotational speed of the rotating electric machine is in the vicinity of 0, and
when the operating point of the rotating electric machine is determined to be within the very-low-speed region or the short-time operation region, the overheat protection unit determines whether the temperature detection target is in the overheated state based on the electric current detected by the current sensor.

4. The control apparatus as set forth in claim 1, wherein
the system is installed in a vehicle,
the vehicle has wheels including a driving wheel to which mechanical power is transmitted from the rotor of the rotating electric machine, and a mechanical brake apparatus that applies frictional braking torque to the wheels, and
in a lower-speed-side region of the continuous operation region, a torque upper limit defining a boundary of a region where the rotating electric machine functions as an electric generator is set to be lower than a torque upper limit defining a boundary of a region where the rotating electric machine functions as an electric motor.

5. The control apparatus as set forth in claim 1, wherein
the system is installed in a vehicle,
the vehicle has wheels including a driving wheel to which mechanical power is transmitted from the rotor of the rotating electric machine, and a mechanical brake apparatus that applies frictional braking torque to the wheels, and
in a higher-speed-side region of the continuous operation region, a torque upper limit defining a boundary of a region where the rotating electric machine functions as an electric generator is set to be higher than a torque upper limit defining a boundary of a region where the rotating electric machine functions as an electric motor.

6. The control apparatus as set forth in claim 1, wherein
a torque upper limit defining a boundary of the continuous operation region is set such that the lower a voltage utilization rate of the inverter, the lower the torque upper limit

7. The control apparatus as set forth in claim 1, wherein
the continuous operation region is a region where field-weakening current flowing through the stator windings is lower than or equal to a predetermined current.

8. The control apparatus as set forth in claim 1, wherein
the system is installed in a vehicle that has a driving wheel to which mechanical power is transmitted from the rotor of the rotating electric machine,
in the continuous operation region, an operating point at which the torque of the rotating electric machine is 0 and the rotational speed is highest is a specific operating point, and
the rotational speed defining the specific operating point is set to the rotational speed of the rotating electric machine when the vehicle travels on a road at a legal maximum speed.

9. The control apparatus as set forth in claim 8, wherein
the rotational speed defining the specific operating point is set to be lower than or equal to the rotational speed of the rotating electric machine at which a peak value of a line-to-line voltage induced in the stator windings with rotation of the rotor becomes equal to a voltage of the electric power storage unit.

10. The control apparatus as set forth in claim 1, wherein
the system is installed in a vehicle,
the vehicle has wheels including a driving wheel to which mechanical power is transmitted from the rotor of the rotating electric machine, and a mechanical brake apparatus that applies frictional braking torque to the wheels,
in the continuous operation region, an operating point at which the torque of the rotating electric machine is 0 and the rotational speed is highest is a specific operating point, and
the rotational speed defining the specific operating point is set to the rotational speed of the rotating electric machine at which traveling speed of the vehicle reaches a terminal speed when the vehicle travels on a road with a predetermined downhill slope without frictional braking torque applied by the brake apparatus to the wheels of the vehicle and without mechanical power applied by mechanical power generation apparatuses including the rotating electric machine to the driving wheel.

11. The control apparatus as set forth in claim 10, wherein
the rotational speed defining the specific operating point is set to be lower than or equal to the rotational speed of the rotating electric machine at which a peak value of a line-to-line voltage induced in the stator windings with rotation of the rotor becomes equal to a voltage of the electric power storage unit.

12. The control apparatus as set forth in claim 1, wherein
when the operating point of the rotating electric machine is determined to be within the continuous operation region and the temperature detected by the temperature sensor is higher than a limit start temperature, the overheat protection unit determines that the temperature detection target is in the overheated state, and
when the operating point of the rotating electric machine is determined to be within the short-time operation region, the overheat protection unit performs an integration process on the electric current detected by the current sensor and determines whether the temperature detection target is in the overheated state based on a current integrated value resulting from the integration process.

13. The control apparatus as set forth in claim 12, wherein
the overheat protection unit also determines whether a processing load of the rotating electric machine control unit is lower than or equal to a predetermined load, and
when the processing load of the rotating electric machine control unit is determined to be lower than or equal to the predetermined load, the overheat protection unit performs, regardless of whether the operating point of the rotating electric machine is within the continuous operation region or the short-time operation region, the integration process on the electric current detected by the current sensor and determines whether the temperature detection target is in the overheated state based on the current integrated value resulting from the integration process.

14. A program for a control apparatus to be applied to a system,
the system comprising:
a rotating electric machine including a rotor and stator windings, wherein operation regions of the rotating electric machine include a continuous operation region where the rotating electric machine can operate continuously, and a short-time operation region that is adjacent to the continuous operation region and on a higher-torque side and a higher-speed side of the continuous operation region;
an electric power storage unit; and
an inverter including upper-arm and lower-arm switches and electrically connecting the stator windings and the electric power storage unit,
the control apparatus comprising:
a temperature sensor that detects a temperature of a temperature detection target which is at least one of the rotating electric machine and the inverter;
a current sensor that detects electric current flowing through the temperature detection target, the current sensor having higher responsiveness than the temperature sensor; and
a computer,
the program being configured to cause the computer to execute:
a process of calculating a command value which is either a command torque or a command rotational speed of the rotating electric machine;
a process of performing, based on the calculated command value, switching control of the upper-arm and lower-arm switches so as to control torque of the rotating electric machine to the command torque;
a process of determining whether an operating point of the rotating electric machine, which is defined by the torque and rotational speed of the rotating electric machine, is within the continuous operation region or the short-time operation region;
a process of determining, when the operating point is determined to be within the continuous operation region, whether the temperature detection target is in an overheated state based on the temperature detected by the temperature sensor;
a process of determining, when the operating point is determined to be within the short-time operation region, whether the temperature detection target is in the overheated state based on the electric current detected by the current sensor; and
a process of controlling, when the temperature detection target is determined to be in the overheated state, the torque of the rotating electric machine to a limit torque that is lower than the command torque.
